(19) United States
(12) Patent Application Publication
(10) Pub. No.: US 2026/0088020 A1
(43) Pub. Date: Mar. 26, 2026

(54) CUSTOMIZED KEYWORD SPOTTING USING CONTEXTUALIZED MODELING

(71) Applicant: Meta Platforms Technologies, LLC, Menlo Park, CA (US)

(72) Inventors: Tyler Vuong, New York, NY (US); Ming Sun, Seattle, WA (US); Zhaojun Yang, Brookline, MA (US)

(21) Appl. No.: 19/340,766

(22) Filed: Sep. 25, 2025

Related U.S. Application Data
(60) Provisional application No. 63/699,532, filed on Sep. 26, 2024.

(51) Int. Cl. G10L 15/08; G06F 40/166; G06F 40/284; G10L 15/06; G10L 15/16

(52) U.S. Cl. CPC G10L 15/08; G06F 40/166; G06F 40/284; G10L 15/063; G10L 15/16; G10L 2015/088

(57) ABSTRACT

A method to train a contextualized custom keyword spotting model by adapting a contextualized automatic speech framework with modified training labels. The target training labels may include the words in the ground-truth transcript that also appear in the input bias text and are then used to train the model with loss determination. This approach enables the building of customized keyword spotting models without additional alignment or word-segmented data.

### RELATED APPLICATION

This application claims priority to U.S. Provisional Application Ser. No. 63/699,532, filed Sep. 26, 2024, entitled “Customized Keyword Spotting Using Contextualized Modeling,” which is incorporated herein by reference.

### TECHNOLOGICAL FIELD

The present invention relates generally to speech recognition systems, and more particularly to customized keyword spotting models that can detect arbitrary keywords specified by a user.

### BACKGROUND

Keyword spotting systems are used as the first stage of interaction with voice assistants and other speech-controlled devices. Keyword spotting models are typically trained to recognize a fixed set of predefined keywords designed to activate a system. However, as systems become more comprehensive, a more expansive bank of words is required to effectively operate electronic device including being more responsive to user inputs.

### SUMMARY

The disclosed subject matter may provide systems and methods for customized keyword spotting, which may use a contextualized connectionist temporal classification (CTC) modeling approach. A customized keyword spotting model may be trained using input audio, corresponding transcripts, and randomly selected input bias text. The training labels may be modified to include only words from the transcript that overlap with the input bias text. This may train the model to predict words relevant to the input bias text while ignoring other speech, aligning with the inference-time goal of detecting a specified keyword.

For example, Jimmy instructs the wearable device system to include a subset of keywords into a keywords bank including sports scores for a specific team(s) and the weather in a specific location(s). Jimmy can then verbally tell the wearable device to tell him the weather and system responds with exactly the location of the weather previously specified by Jimmy.

The customized keyword spotting model includes an audio encoder to process input audio, a text encoder to process input bias text (i.e., the target keyword during inference), and one or more text biasing layers that combine the audio and text embeddings. The model may be trained using the CTC loss based on the modified training labels.

During inference, the target keyword to be detected may be provided as the input bias text. The model may process input audio and determine if the keyword is present based on the predicted probabilities for each token. This may enable detection of arbitrary keywords specified at runtime, without needing to retrain the model.

In one aspect, a method includes receiving an input audio signal; receiving a transcript that corresponds with the input audio signal; receiving an input bias text; modifying the transcript to include only words that overlap with the input bias text; generating audio embeddings based on processing the input audio signal through an audio encoder; generating text embeddings based on processing the input bias text through a text encoder; combining the audio embeddings and text embeddings using a text biasing layer; providing predicted probabilities for each token based on the combined embeddings; determining a loss between the predicted probabilities and the modified transcript using a determined loss; and updating parameters of the model based on the determined loss.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### DESCRIPTION OF THE DRAWINGS

FIGS. 1A-1B illustrates an example scenario for keyword spotting, in accordance with some embodiments.

FIG. 2A illustrates an example functional diagram for training a model associated with customized keyword spotting.

FIG. 2B illustrates an example functional diagram for performing inference associated with customized keyword spotting.

FIG. 3 illustrates an example method for training a customized keyword spotting model as disclosed herein.

FIG. 4 illustrates an example method for performing customized keyword spotting using a trained model as disclosed herein.

FIG. 5 illustrates a framework associated with machine learning and/or artificial intelligence (AI).

FIG. 6 illustrates an example block diagram of an exemplary computing device suitable for implementing aspects of the disclosed subject matter.

FIGS. 7A, 7B, 7C-1, and 7C-2 illustrate example MR and AR systems, in accordance with some embodiments.

The figures depict various embodiments for purposes of illustration only. One skilled in the art will readily recognize from the following discussion that alternative embodiments of the structures and methods illustrated herein may be employed without departing from the principles described herein.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Some embodiments of the present invention will now be described more fully hereinafter with reference to the accompanying drawings, in which some, but not all embodiments of the invention are shown. Various embodiments of the invention may be embodied in many different forms and should not be construed as limited to the embodiments set forth herein. Like reference numerals refer to like elements throughout.

It is to be understood that the methods and systems described herein are not limited to specific methods, specific components, or to particular implementations. It is also to be understood that the terminology used herein is for the purpose of describing particular embodiments only and is not intended to be limiting.

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiogramhy (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Flexible Keyword Spotting Model

The disclosed subject matter provides apparatuses, systems, and methods for customized keyword spotting that can detect arbitrary keywords specified by a user, without requiring retraining of the model. Embodiments leverage a contextualized modeling approach adapted from automatic speech recognition (ASR) systems, combined with a novel training label modification technique. This enables training of a flexible keyword spotting model using only existing ASR training data, without need for specialized dataset preprocessing or word-level alignments.

Conventional keyword spotting systems are typically designed to recognize a fixed set of predefined keywords. While effective for common wake words or commands, this approach limits flexibility and personalization. Enabling users to specify their own custom keywords to be detected would provide a more tailored experience. However, customized keyword spotting for arbitrary words or phrases specified at runtime presents several challenges.

Existing approaches to customized keyword spotting often frame it as a verification problem-determining whether an input audio segment matches a given keyword. This typically requires breaking long utterances into shorter segments and creating pairs of matching and non-matching audio-text examples for training. Such preprocessing adds complexity and requires word-level segmentation or alignment information that may not be readily available in existing datasets.

The disclosed subject matter adapts techniques from contextualized automatic speech recognition to the keyword spotting task. Rather than verifying audio-text pairs, the model learns to transcribe speech while attending to relevant parts of an input text bias. By modifying the training labels, the model can be taught to output only words matching the bias text, effectively spotting specified keywords while ignoring other speech.

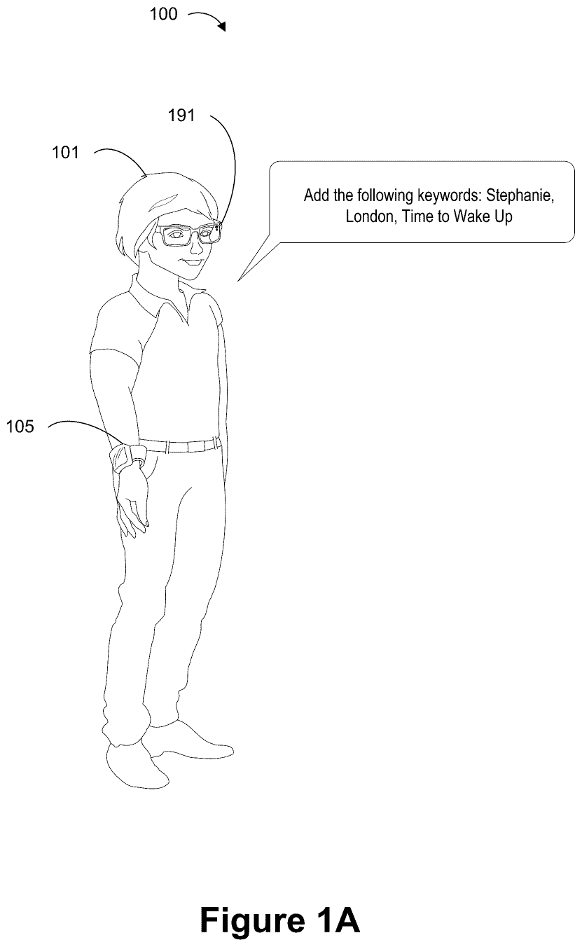

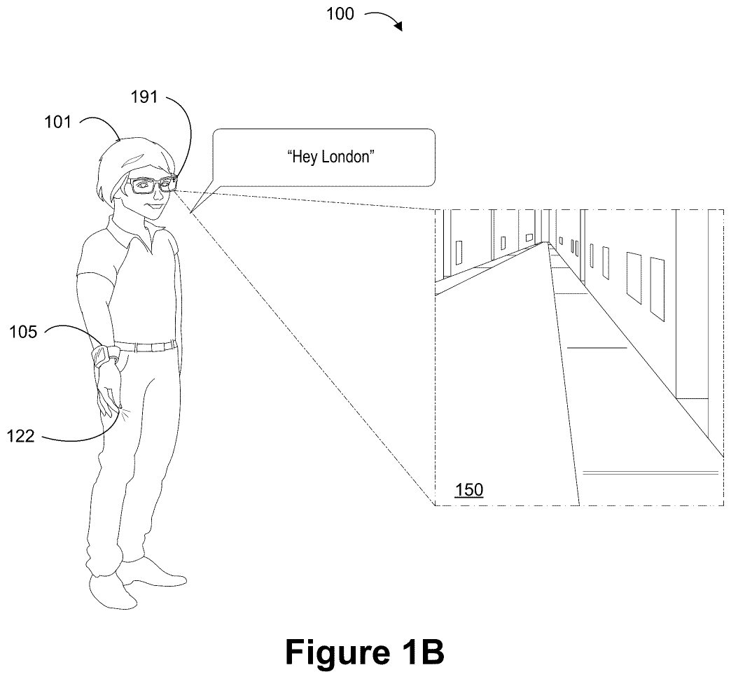

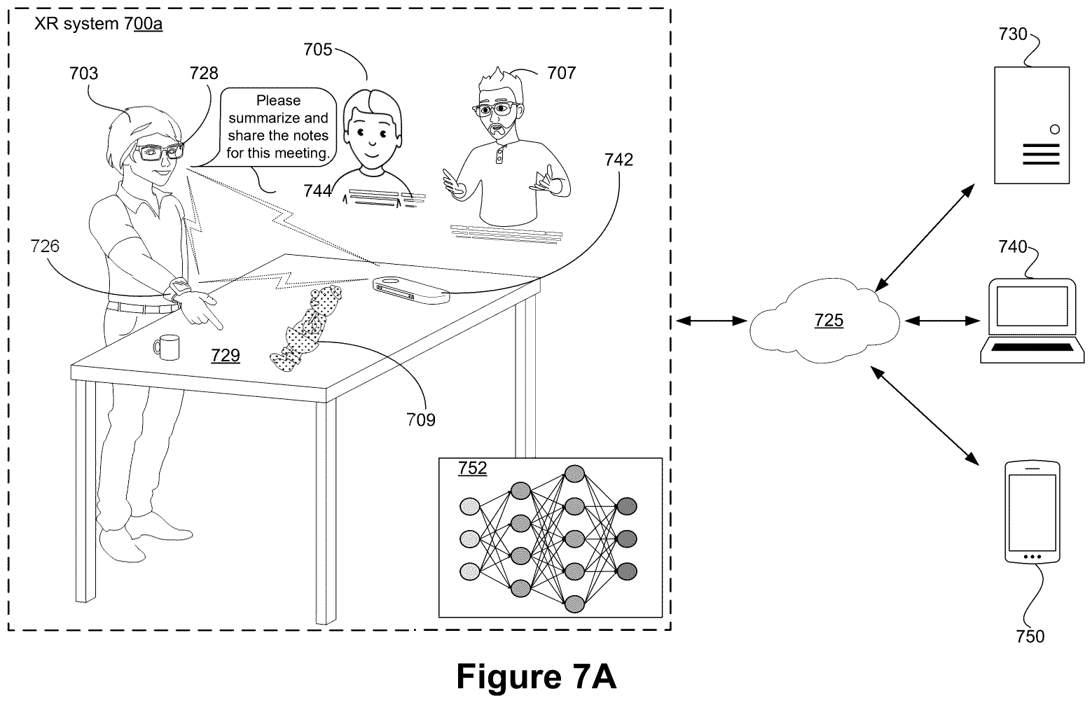

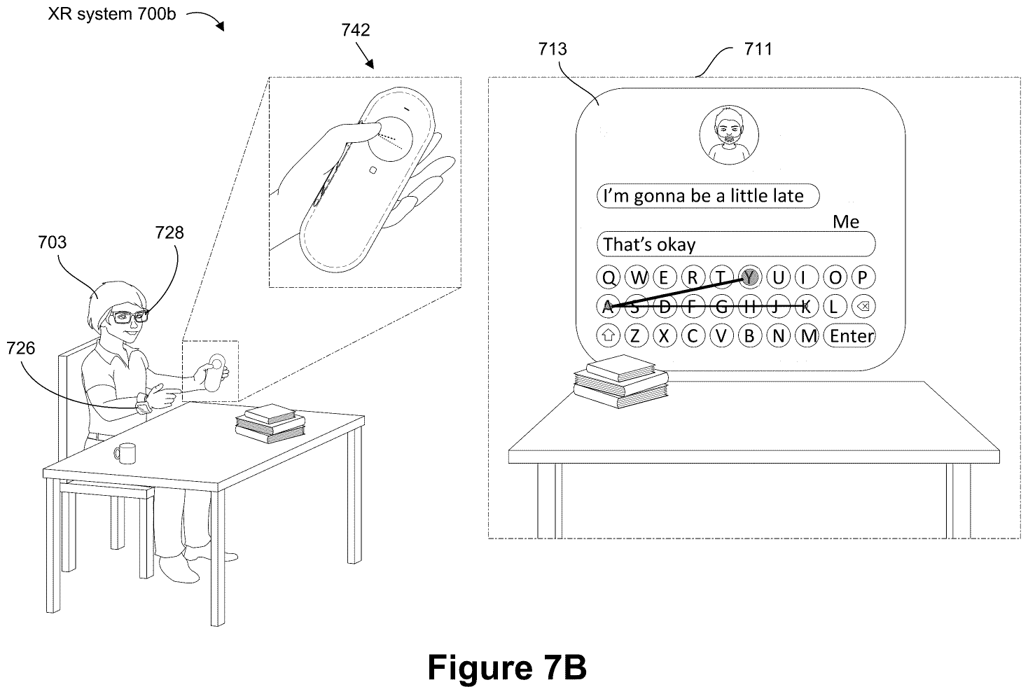

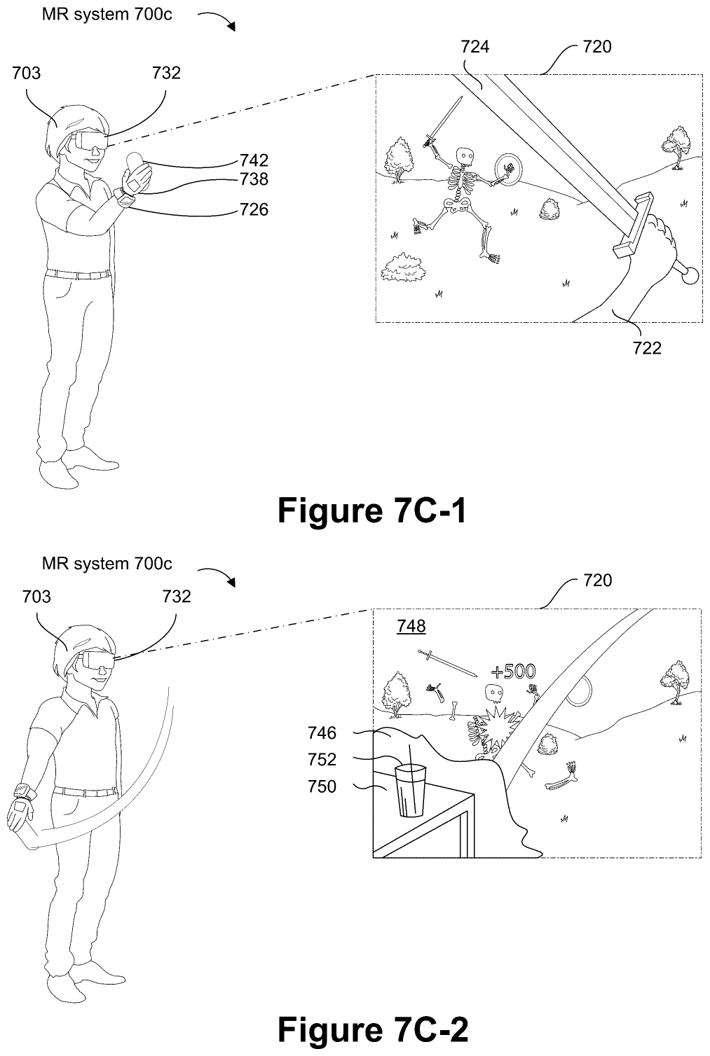

FIG. 1A illustrates a scene 100 at a first point in time which illustrates a user 101 inputting keywords used to trigger the AI Assistant. The user 101 is wearing a head-wearable device 191 and a wrist-wearable device 105 that is communicatively coupled to the head-wearable device 191. In some embodiments, while the head-wearable device 191 is in a sleep mode it's configured to receive a command that activates one or more sensors and/or a virtual agent at the head-wearable device 191. FIG. 1A illustrates the user 101 inputting custom keywords and phrases configured to activate one or more sensors and/or a virtual agent at the head-wearable device 191. In some embodiments, the user 101 inputs the keywords or phrases via a smartphone (e.g., FIG. 7; smartphone 750), via a hand gesture 122, via a manipulatable display at a wrist-wearable device 105, or by verballing inputting the keywords/phrases. For example, the user 101 inputs a name or nickname for their head-wearable device (e.g., Stephanie), their favorite place (e.g., London), or a phrase they use more often (e.g., time to wake up).

FIG. 1B illustrates scene 100 at a second point in time which illustrates the user 101 speaking one of the keyword phrases which activates the display at the head-wearable device 191 and generates point of view 150. In some embodiments, a particular keyword can open a different point of view 150 such as a camera, a video recording, a text message, etc.

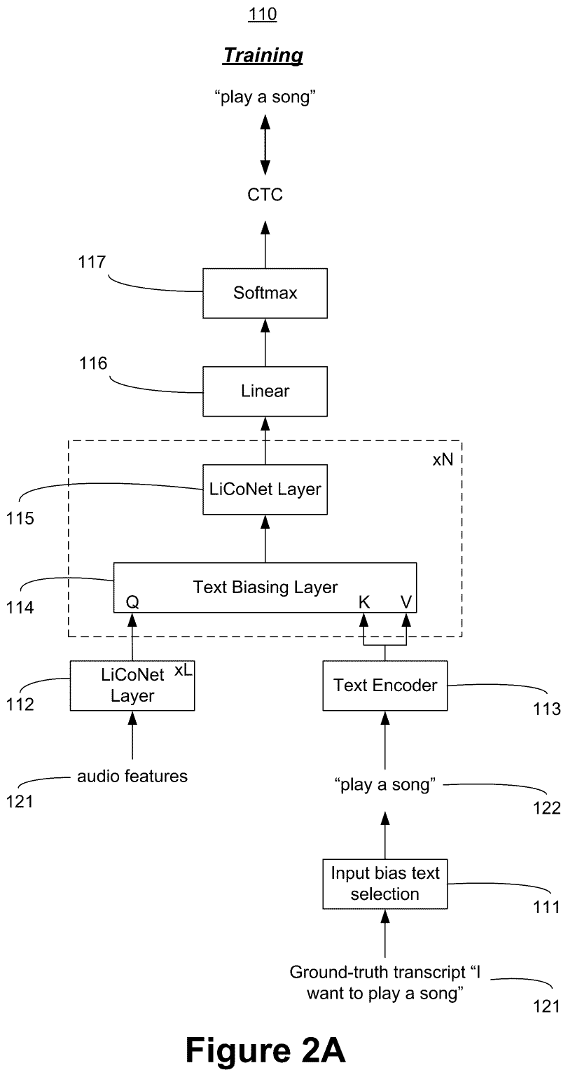

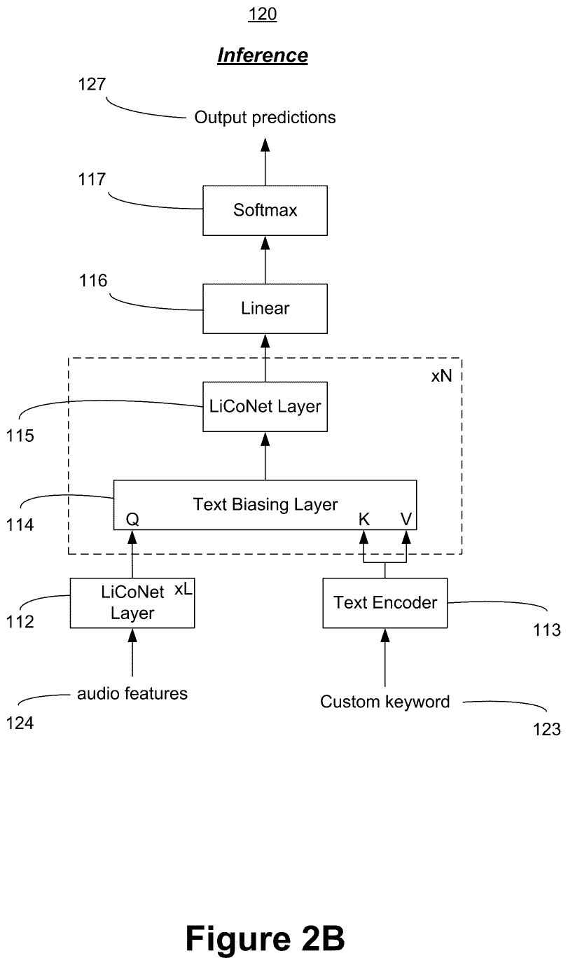

FIG. 2A illustrates an example functional diagram for training a model associated with customized keyword spotting, referenced herein as contextualized custom keyword spotting (CC-KWS) model 110. CC-KWS model 110 may include audio encoder 112, text encoder 113, and a text biasing layer 114, among other components. As further described herein, similar to aspects of a contextualized automatic speech recognition (ASR) framework, rather than using the ground-truth transcript as the training label, the training label may be modified to be more suitable for the keyword spotting task.

Audio encoder block 112 may process an input audio signal to generate audio embeddings. In an example, audio encoder 112 may include a stack of linearized convolution network (LiCoNet) layers. LiCoNet is a neural network architecture designed for on-device speech processing. The basic LiCoNet block uses a bottleneck residual structure based on 1D convolutions, allowing each convolutional operator to be transformed into an equivalent linear operator for hardware efficiency, which may assist with hardware efficiency during inference.

Input bias text selection block 111 may be used to select a subset of text from a ground-truth transcript of the audio. During training, a variety of input bias text may be used to build CC-KWS model 110 towards detecting any arbitrary keyword. For example, positive training examples may be used by randomly choosing consecutive words 121 (e.g., one to three consecutive words) from the ground-truth transcript of the utterance as input bias text 122. These are considered positive examples since the input bias text 122 may include words that are spoken in the ground-truth transcript of the utterance. To generate negative examples where the input bias text likely may not appear in the ground-truth transcript of the utterance, words (which may be from a different utterance transcript in the training batch) may be selected (e.g., one to three words) as the input bias text. Table 1 provides an example, in which the consecutive words 121 of the ground-truth transcript includes “where have you been” and the input bias text is chosen as described regarding input bias text selection block 111. The strike-through words do not overlap with the transcript. As further disclosed herein, the training label may be modified to be words that overlap with the transcript to enable customized keyword spotting. The process of input bias text selection block 111 may mimic the common KWS scenario in which the input bias text does not appear in the actual utterance and the KWS model needs to reject the audio. For each utterance in the batch, there may be implemented probability (e.g., 50%) between being a positive or negative example. The disclosed negative sampling strategy may combine simplicity and good performance in contrast to other possible implementations. It is contemplated that hard negative sampling strategies could be beneficial. During training, randomly-selected words from the transcripts may be used as the input bias text. As further disclosed herein, during inference, the custom keyword may be used as the input bias text.

TABLE 1

| Input Bias Text | CTC Training Label |
|---|---|
| you been | “you been” |
| have you [symbol] | “have you” |
| [symbol] | <BLANK> |

As disclosed herein, contextualized ASR models may be trained to predict the ground-truth utterance transcript while leveraging the input bias text. However, since an objective of the CC-KWS model 110 during inference is to primarily recognize the target keywords while ignoring the other words in the utterance, the training labels may be modified to match the inference objective. For example, the training label of each utterance may be modified to include the words in the ground-truth transcript that are also in the input bias text. In the case of negative examples where no words match, the target training label is modified to the <BLANK> token or the like indicator. Examples are shown in Table 1. Text biasing layers 114 learn to combine the audio and bias text embeddings to predict the words relevant to the input bias text 122. By including negative examples during training, CC-KWS model 110 learns not to just copy the input bias text.

Modifying the training labels enables the building of the CC-KWS model 110 that predicts the target keywords during inference while ignoring other words. This can be seen as using text to implicitly limit the vocabulary size and reduce the output space, turning the CC-KWS model 110 into a specialized keyword spotting model that only recognizes a small set of words. This approach may enable the model to obtain better KWS performance compared to a general ASR model that tries to predict all of the words in the utterance.

Leveraging the contextual ASR framework to develop a CC-KWS model 110 may allow for the following. First, the CC-KWS model 110 may be trained using the alignment-free CTC loss or the like that may be used in ASR. This approach does not require any prior word-level segmentation or alignment of the data unlike other customized keyword spotting approaches that are based on utterance-level detection. Utterance-level detection approaches require segmenting long utterances into smaller utterances of few words. These approaches compare whether the input audio embeddings match the target keyword so the training data has to be segmented into smaller utterances using an external alignment method. Second, the disclosed approach may be relatively easy to implement, such as not requiring any additional loss functions, not requiring hard negative sampling strategies, or not requiring an expensive text encoder to compute text embeddings.

Text encoder block 113 may be included in CC-KWS model 110. A biasing list may be a single phrase (which may be referred to as the input bias text) and may be used to bias the CC-KWS model 110. The input bias text may be first tokenized by a sentence piece model to get the input bias tokens. In addition to the input bias tokens, an additional <NO BIAS> token may be added so the network may utilize this token when there is no relation between the input bias text and the input audio. See example in Table 1. Unlike other methods that may use an expensive text encoder to encode the contextual information, herein a relatively simple learnable embedding layer may be used that maps each token to an embedding. This may be a computationally efficient approach to compute text embeddings and more practical for small-footprint and on-device applications.

Text biasing layer 114 may combine the audio embeddings of audio encoder block 112 and text embeddings of text encoder block 113. CC-KWS model 110 may be trained to learn the relationship between the input audio 121 and the input bias text 122 by passing these inputs through several biasing layers. Each biasing layer may include a single transformer block containing a multi-head cross-attention layer, linear layers with layer normalization layers, and residual connections. The audio embeddings of audio encoder block 112 and input bias text embeddings of text encoder block 113 may be combined using a multi-head cross-attention layer, with the audio embeddings serving as the query and the input bias text embeddings functioning as both keys and values. This use of a cross-attention layer to combine audio and text embeddings has proven effective in leveraging text to bias the ASR model. Following each biasing layer, a convolutional network layer block 115 (e.g., LicoNet layer) may process the outputs before passing them to the next biasing layer. This next biasing layer refers to having multiple text biasing blocks (passing through block 114→115) being repeated N times before finally being passed to the linear layer 116 (e.g., xN). Linear layer block 116 receives the output embeddings from convolutional network layer block 115 and processes the received output embeddings to produce logits (unnormalized predictions). The logits may be passed to softmax block 117 to determine normalized probabilities, which may result in the predicted posterior probabilities for every token at each frame.

FIG. 2B illustrates an example functional diagram for performing inference associated with customized keyword spotting. The functional diagram is similar to FIG. 2A, but there is no training associated with ground-truth transcript and audio. In FIG. 2B, input audio 124 may be from a user and the custom keyword may be provided to a device during setup of user device (e.g., head-wearable device 111, wrist-wearable device 120, and/or another communicatively coupled device). As disclosed herein, there may be processing by audio encoder block 112, text encoder block 113, text biasing layer block 114, convolutional network layer block 115, linear layer block 116, or softmax block 117 in order to provide output prediction 127.

With reference to the output prediction 127, the output posterior probabilities are then processed by a keyword-specific decoder. In this example, the decoder will be configured to continuously output a score that indicates the likelihood the “custom keyword” was spoken. once the score is greater than some predefined threshold, the model triggers some action depending on the use case. For example, if users wanted a new wake word to wake up the device instead of using “hey/okay speaker”, they could provide a custom keyword to wake up the smart device. The user can also define a custom keyword so when the user says that custom keyword, a user-defined action is taken by the user device (e.g., smartphone, smart speaker, or other device).

During inference using CC-KWS 110, custom keyword 123 (e.g., target keyword) may be used as the input bias text and sliding window decoding may be used. In an example, the posterior probabilities predicted by the network inside the decoding window may be first smoothed and then the log probabilities are computed. The best decoding path for a given custom keyword candidate may be selected using an appropriate probability estimation algorithm (e.g., the Max Pooling Viterbi algorithm, instead of summing the log probabilities, the maximum log probability in the sequence of the same token predictions may be computed). The decoding score may be compared to a threshold to determine if the utterance contains the keyword. The output predictions are frame-level posterior probabilities and not the decoding score. An additional decoding method (e.g., Max Pooling Viterbi algorithm) may be used to process the frame-level posterior probabilities to output decoding scores.

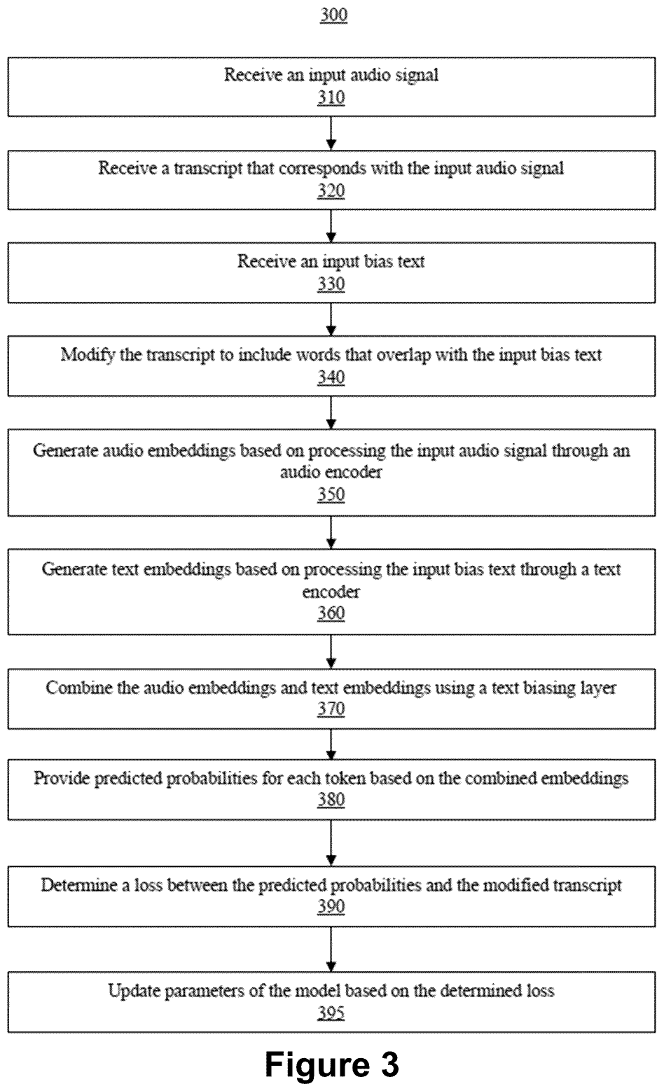

FIG. 3 illustrates an example method 300 for training a customized keyword spotting model as disclosed herein. At step 310, an input audio signal may be received. At step 320, a corresponding transcript may be received. At step 330, an input bias text may be received or generated. During training, this bias text may be randomly selected. It is also contemplated herein that positive examples may be created by selecting 1-3 consecutive words from the ground truth transcript. Negative examples may be created by selecting words from a different utterance's transcript.

At step 340, the transcript may be modified to include only words that overlap with the input bias text. If no words overlap, the modified transcript may include only a blank token. This modification may train the model to output only words relevant to the bias text while ignoring other speech.

At step 350, audio embeddings may be generated by processing the input audio through an audio encoder. At step 360, text embeddings may be generated by processing the input bias text through a text encoder. At step 370, the audio and text embeddings may be combined using one or more text biasing layers.

At step 380, based on the combined embeddings, the model may provide predicted probabilities for each token. At step 390, a loss may be determined between these predictions and the modified transcript using a loss function (e.g., CTC). At step 395, the parameters of the model may be updated based on this determined loss.

By repeating this process over a large training dataset, the model learns to transcribe only words matching the input bias text. This training may be performed using existing ASR datasets without requiring any additional preprocessing, segmentation, or alignment information.

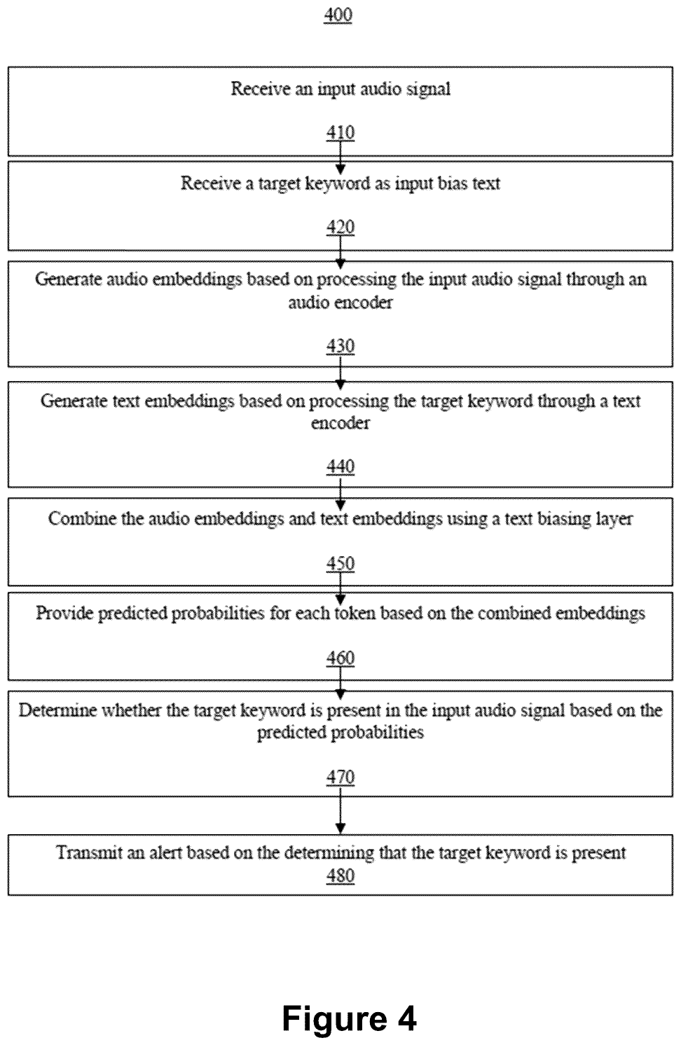

FIG. 4 illustrates an example method 400 for performing customized keyword spotting using a trained model as disclosed herein. At step 410, an input audio signal to be analyzed may be received. At step 420, a target keyword to be detected may be received. The target keyword serves as the input bias text during inference.

At step 430, audio embeddings may be generated by processing the input audio through the audio encoder. At step 440, text embeddings may be generated by processing the target keyword through the text encoder. At step 450, the audio and text embeddings may be combined using the text biasing layer(s).

At step 460, based on the combined embeddings, the model may provide predicted probabilities for each token. At step 470, the method may determine whether the target keyword is present in the input audio based on these predicted probabilities. It is contemplated herein that various decoding techniques may be used for this determination. In one embodiment, a sliding window approach may be used, optionally with smoothing of probabilities within the window. The maximum log probability of the keyword token sequence may be computed and compared to a threshold. At step 480, if the keyword is determined to be present, an alert or other appropriate action may be triggered.

This customized keyword spotting approach provides several technical effects in consideration of other techniques. Leveraging existing datasets allows the model to be trained using standard ASR datasets without requiring word-level segmentation or alignment information, greatly simplifying data preparation and enabling use of large existing datasets. The training process is simplified by using only the standard CTC loss function, without need for additional specialized losses or complex sampling strategies. Runtime flexibility is achieved as the model can detect arbitrary keywords specified at inference time, without any retraining required, enabling truly customized keyword spotting. Improved accuracy is attained by focusing only on the specified keyword during both training and inference, allowing the model to achieve improved detection accuracy compared to conventional ASR-based approaches. Lastly, an efficient architecture is employed through the use of efficient model components like LiCoNet and a simple text encoder, enabling on-device deployment.

In some embodiments, the target keyword is a custom wake phrase. The custom wake phrase can replace a default wake phrase to invoke or activate a virtual assistant (e.g., an artificial-intelligence assistant that includes a machine learning model). For example, a user provides an input that sets the custom wake phrase as “Hey Assistant.” Next, in accordance with a determination that the custom wake phrase “Hey Assistant” is received by the device (e.g., a pair of smart glasses, a smart phone, a wrist-wearable device, or any other type of computing device), the device activates the virtual assistant. In some embodiments, the custom wake phrase is in addition to the default wake phrase.

In some embodiments, the user configures the custom wake phrase by providing a user input with the custom wake phrase. For example, the user input is a text input via a virtual keyboard on a smart phone. In another example, the user input is a speech input. The speech input can be processed by a speech to text system. In yet another example, the user input includes one or more gestures captured by a wrist-wearable device (e.g., the wrist-wearable device captures neuromuscular signals associated with the one or more gesture, and the neuromuscular signals are associated with one or more characters). After providing the user input, the system displays the user input via a communicatively coupled display (e.g., via a display of a pair of smart glasses, a display of a smartphone, a display of a wrist-wearable device, or any other display device). Next, the user is prompted to confirm the user input received by the system. In response to a user input confirming the custom wake phrase, the system adds the custom wake phrase so that utterance of the custom wake phrase causes the associated virtual assistant to activate.

In some embodiments, different custom wake phrases are associated with different virtual assistants. For example, one assistant is customized to handle work related tasks, and another assistant is customized to handle personal tasks. In another example, one assistant is customized for messaging (e.g., emails, texts, social media comments, or other types of messages), another assistant is customized for changing settings of the device (e.g., increasing brightness, muting notifications, or other types of settings), and yet another assistant is customized for capturing audiovisual information (e.g., capturing a picture, a video, a voice memo, or other types of audiovisual information).

In some embodiments, the user can customize commands to the virtual assistants. The customization of the commands can be based on the same customized keyword spotting model as for the custom wake phrases. For example, a user can map a custom command phrase to an operation at the device (or sequence of operations). For example, in response to a user speech input of “snap a picture” the device captures a picture. In this example, the customize command is “snap a picture” and the default command associated with the same operation is “take a picture.” The customization can better align with language that is frequently used by the user without the user needing to learn or memorize a set of commands for the device.

In some embodiments, a lightweight routing assistant is configured to detect the one or more custom wake phrases and/or the default wake phrase. In response to detecting the one or more custom wake phrases and based on the custom wake phrase detected, the lightweight routing assistant can wake a respective virtual assistant associated with the custom wake phrase. The lightweight routing assistant can utilize less resources (e.g., computational resources) than a virtual assistant, which can improve battery life and increase user comfort by reducing the heat output.

In some embodiments, the customized keyword spotting model is language agnostic and/or multilingual (e.g., the customized keyword spotting model can concurrently recognize more than one language (e.g., English, Spanish, French, German, Chinese, Korean, Japanese, or any other language). For example, a bilingual user speaking English and Chinese can set the custom wake phrase that includes a portion in English and another portion that is in Chinese. In some embodiments, the customized keyword spotting model can recognize any arbitrary word.

In some embodiments, the one or more virtual assistants and/or the lightweight routing assistant are based on the customized keyword spotting model as described above. In some embodiments, the user can select from one or more predefined customized wake phrases. In some embodiments, the one or more virtual assistants, the lightweight routing assistant, and/or the customized keyword spotting model execute on-device or on a local constellation of devices. For example, the aforementioned model does not require connection with a remote server (e.g., a cloud server).

### EXAMPLE EMBODIMENTS

(A1) In some embodiments, a method for training a customized keyword spotting model, including receiving an input audio signal, receiving a transcript that corresponds with the input audio signal, receiving an input bias text, modifying the transcript to include words that overlap with the input bias text to generate a modified transcript, generating audio embeddings based on processing the input audio signal through an audio encoder, generating text embeddings based on processing the input bias text through a text encoder, combining the audio embeddings and text embeddings using a text biasing layer to generate combined embeddings, providing predicted probabilities for respective tokens based on the combined embeddings, determining a loss between the predicted probabilities and the modified transcript using Connectionist Temporal Classification (CTC) loss, and updating parameters of the model based on the determined loss.

(A2) In some embodiments of A1, the input bias text is randomly selected from the transcript.

(A3) In some embodiments of A1-A2, the text encoder includes a learnable embedding layer.

(A4) In some embodiments of any of A1-A3, the text biasing layer includes a transformer block with a multihead cross-attention layer.

(A5) In some embodiments of any of A1-A4, further comprising repeating the combining step using multiple text biasing layers.

(A6) In some embodiments of any of A1-A5, modifying the transcript includes replacing the transcript with a blank token if no words overlap with the input bias text.

(A7) In some embodiments of any of A1-A6, further comprising training the model using a dataset without word-level segmentation or alignment information.

(A8) In some embodiments of any of A1-A7, the audio encoder includes a stack of linearized convolution network (LiCoNet) layers.

(A9) In some embodiments of any of A1-A8, further comprising adding a no bias token to the input bias text.

(B1) In accordance with some embodiments, a method for keyword spotting that includes receiving an input audio signal, receiving a target keyword as input bias text, generating audio embeddings based on processing the input audio signal through an audio encoder, generating text embeddings based on processing the target keyword through a text encoder, combining the audio embeddings and text embeddings using a text biasing layer to generate combined embeddings, providing predicted probabilities for each token of one or more tokens based on the combined embeddings, determining whether the target keyword is present in the input audio signal based on the predicted probabilities, and transmitting an alert based on the determining that the target keyword is present.

(B2) In some embodiments of B1, providing the predicted probabilities comprises computing a maximum log probability in a sequence of predicted probabilities for the one or more tokens.

(B3) In some embodiments of B1-B2, providing the predicted probabilities includes using a technique that includes using computation of the maximum log probability in the sequence of the same token predictions.

(B4) In some embodiments of any of B1-B3, determining whether the target keyword is present is based on comparing the predicted probabilities to a predetermined threshold.

(B5) In some embodiments of any of B1-B4, the text encoder includes a learnable embedding layer.

(B6) In some embodiments of any of B1-B5, the text biasing layer includes a transformer block with a multihead cross-attention layer.

(B7) In some embodiments of any of B1-B6, where the audio embeddings and the text embeddings are combined using the text biasing layer without external alignment information.

(B8) In some embodiments of any of B1-B7, the audio encoder includes a stack of linearized convolution network (LiCoNet) layers.

(C1) In accordance with some embodiments, a device including a processor, and a memory storing instructions that, when executed by the processor, cause the device to: receive an input audio signal, determine the use of a target keyword in the input audio signal based on a customized keyword spotting model associated with spotting one or more keywords in the input audio signal, where the customized keyword spotting model includes: receiving the input audio signal, receiving the target keyword as input bias text, generating audio embeddings based on processing the input audio signal through an audio encoder, generating text embeddings based on processing the target keyword through a text encoder, combining the audio embeddings and text embeddings using a text biasing layer to generate combined embeddings, providing predicted probabilities for each token of one or more tokens based on the combined embeddings, determining whether the target keyword is present in the input audio signal based on the predicted probabilities, and transmitting a message based on the determining that the target keyword is present, and send instructions to execute an action based on the use of the target keyword.

(C2) In some embodiments of any of C1-C2, the action includes executing an operation associated with an application, where the action includes opening the application, transmitting data to the application, playing audio, playing video, display text, or closing the application.

(C3) In some embodiments of any of C1-C3, the device includes a mobile phone, a laptop, a smart speaker, a head mounted display, or a wearable device.

The devices described above are further detailed below, including wrist-wearable devices, headset devices, systems, and haptic feedback devices. Specific operations described above may occur as a result of specific hardware, such hardware is described in further detail below. The devices described below are not limiting and features on these devices can be removed or additional features can be added to these devices.

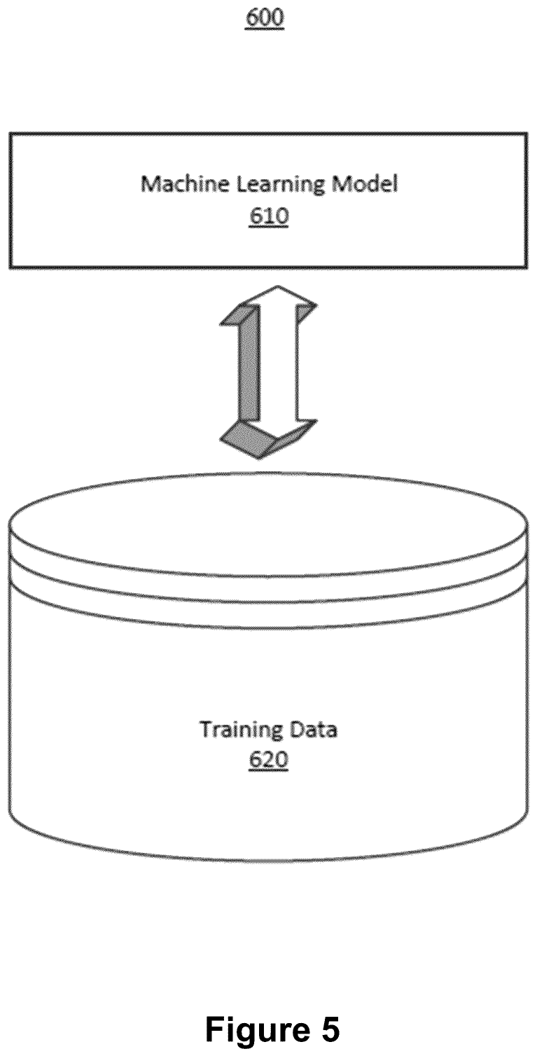

FIG. 5 illustrates a framework 600 associated with machine learning and/or artificial intelligence (AI). The framework 600 may be hosted remotely. Alternatively, the framework 600 may reside within the systems shown in FIGS. 7A-7C-2 and may be processed/implemented by a device. In some examples, the machine learning model 610 (also referred to herein as artificial intelligence model 610) may be implemented/executed by a network device (e.g., server 104). In other examples, the machine learning model 610 may be implemented/executed by other devices (e.g., user device). The machine learning model 610 may be operably coupled with the stored training data in a training database 603 (e.g., database 106). In some examples, the machine learning model 610 may be associated with other operations. The machine learning model 610 may be one or more machine learning models.

In some embodiments, a server (e.g., FIG. 7; one or more servers 730) may be used in whole or in part to train or operate a large language model (LLM) associated with customized keyword spotting. Database 603 may store audio features, transcripts, custom keyword selection, among other information, which in whole or in part may be used as reference data.

In another example, the training data 620 may include attributes of thousands of objects. Attributes may include but are not limited to the size, shape, orientation, position of the object(s), etc. The training data 620 employed by the machine learning model 610 may be fixed or updated periodically. Alternatively, the training data 620 may be updated in real-time based upon the evaluations performed by the machine learning model 610 in a non-training mode. This is illustrated by the double-sided arrow connecting the machine learning model 610 and stored training data 620.

The machine learning model 610 may be designed to examine audio or text as disclosed herein associated with one or more received inputs, based in part on utilizing determined contextual information. This information includes fields like a description, variables defined, data category associated with the variables and the output, and responses to generated prompts. The machine learning model 610 may be a large language model to generate representations, or embeddings, of one or more of the one or more inputs received. These machine learning model 610 may be trained (e.g., pretrained and/or trained in real-time) on a vast amount of textual data (e.g., associated with the one or more inputs), previous responses to one or more prompts generated, and/or data capture of a wide range of language patterns and semantic meanings. The machine learning model 610 may understand and represent the context of words, terms, phrases and/or the like in a high-dimensional space, effectively capturing/determining the semantic similarities between different received inputs, including descriptions and responses to prompts, even when they are not exactly the same.

Example aspects of the present disclosure may deploy a machine learning model(s) (e.g., machine learning model 610) that may be flexible, adaptive, automated, temporal, learns quickly and trainable. Manual operations or brute force device operations may be unnecessary for the examples of the present disclosure due to the learning framework aspects of the present disclosure that are implementable by the machine learning model 610.

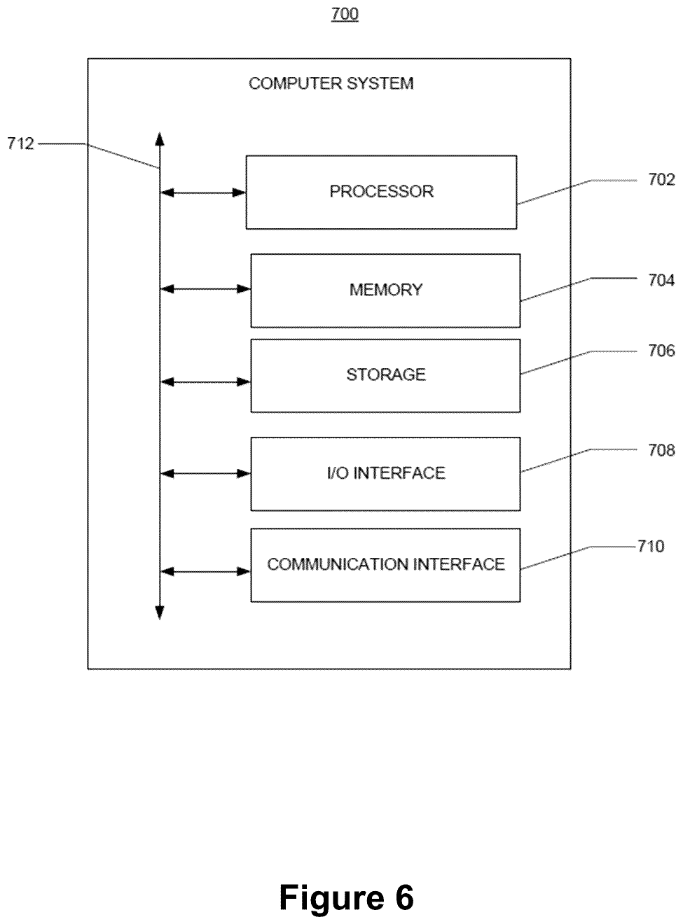

FIG. 6 illustrates an example computer system 700. In examples, one or more computer systems 700 perform one or more steps of one or more methods described or illustrated herein. In particular embodiments, one or more computer systems 700 provide functionality described or illustrated herein. In examples, software running on one or more computer systems 700 performs one or more steps of one or more methods described or illustrated herein or provides functionality described or illustrated herein. Examples include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example, and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In examples, computer system 700 includes a processor 702, memory, storage 706, an input/output (I/O) interface 708, a communication interface 710, and a bus 712 (e.g., communication bus 103). Although this disclosure describes and illustrates a particular computer system having a particular number of particular components in a particular arrangement, this disclosure contemplates any suitable computer system having any suitable number of any suitable components in any suitable arrangement.

In examples, processor 702 includes hardware for executing instructions, such as those making up a computer program. As an example, and not by way of limitation, to execute instructions, processor 702 may retrieve (or fetch) the instructions from an internal register, an internal cache, memory, or storage 706; decode and execute them; and then write one or more results to an internal register, an internal cache, memory, or storage 706. In particular embodiments, processor 702 may include one or more internal caches for data, instructions, or addresses. This disclosure contemplates processor 702 including any suitable number of any suitable internal caches, where appropriate. As an example, and not by way of limitation, processor 702 may include one or more instruction caches, one or more data caches, and one or more translation lookaside buffers (TLBs). Instructions in the instruction caches may be copies of instructions in Memory or storage 706, and the instruction caches may speed up retrieval of those instructions by processor 702. Data in the data caches may be copies of data in Memory or storage 706 for instructions executing at processor 702 to operate on; the results of previous instructions executed at processor 702 for access by subsequent instructions executing at processor 702 or for writing to Memory or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In examples, Memory includes main memory for storing instructions for processor 702 to execute or data for processor 702 to operate on. As an example, and not by way of limitation, computer system 700 may load instructions from storage 706 or another source (such as, for example, another computer system 700) to memory. Processor 702 may then load the instructions from Memory to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory. In particular embodiments, processor 702 executes only instructions in one or more internal registers or internal caches or in Memory (as opposed to storage 706 or elsewhere) and operates only on data in one or more internal registers or internal caches or in Memory (as opposed to storage 706 or elsewhere). One or more memory buses (which may each include an address bus and a data bus) may couple processor 702 to memory. Bus 712 may include one or more memory buses, as described below. In examples, one or more memory management units (MMUs) reside between processor 702 and Memory and facilitate accesses to Memory requested by processor 702. In particular embodiments, Memory includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory may include one or more memories 704, where appropriate. Although this disclosure describes and illustrates particular memory, this disclosure contemplates any suitable memory.

In examples, storage 706 includes mass storage for data or instructions. As an example, and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In examples, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In examples, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In examples, communication interface 710 includes hardware, software, or both providing one or more interfaces for communication (such as, for example, packet-based communication) between computer system 700 and one or more other computer systems 700 or one or more networks. As an example, and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example, and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

While the disclosed systems have been described in connection with the various examples of the various figures, it is to be understood that other similar implementations may be used or modifications and additions may be made to the described examples of a robotic skin or AI robotics platform, among other things as disclosed herein. For example, one skilled in the art will recognize that robotic skin or AI robotics platform, among other things as disclosed herein in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—customized keyword models—as illustrated in the Figures, specific terminology is employed for the sake of clarity. The claimed subject matter, however, is not intended to be limited to the specific terminology so selected.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

This written description uses examples to enable any person skilled in the art to practice the claimed subject matter, including making and using any devices or systems and performing any incorporated methods. Other variations of the examples are contemplated herein. It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

The scope of this disclosure encompasses all changes, substitutions, variations, alterations, and modifications to the example embodiments described or illustrated herein that a person having ordinary skill in the art would comprehend. The scope of this disclosure is not limited to the examples described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

Methods, systems, or apparatus with regard to training a model for customized keyword spotting are disclosed herein. A method, system, or apparatus may provide for receiving an input audio signal; receiving a transcript that corresponds with the input audio signal; receiving an input bias text; modifying the transcript to include only words that overlap with the input bias text; generating audio embeddings based on processing the input audio signal through an audio encoder; generating text embeddings based on processing the input bias text through a text encoder; combining the audio embeddings and text embeddings using a text biasing layer; providing predicted probabilities for each token based on the combined embeddings; determining a loss between the predicted probabilities and the modified transcript using a considered loss (e.g., using CTC); and updating parameters of the model based on the determined loss. The model may comprise a customized keyword spotting model. The input bias text may be randomly selected from the transcript or from a transcript of a different utterance. The text encoder may comprise a learnable embedding layer. The text biasing layer may comprise a transformer block with a multihead cross-attention layer. The combining step may be repeated using multiple text biasing layers. Modifying the transcript may comprise replacing the transcript with a blank token if no words overlap with the input bias text. The model may be trained using a dataset without word-level segmentation or alignment information. The audio encoder may comprise a stack of linearized convolution network (LiCoNet) layers. A no bias token may be added to the input bias text. All combinations (including the removal or addition of steps) in this paragraph are contemplated in a manner that is consistent with the other portions of the detailed description.

A method for keyword spotting may comprise receiving an input audio signal; receiving a target keyword as input bias text; generating audio embeddings based on processing the input audio signal through an audio encoder; generating text embeddings based on processing the target keyword through a text encoder; combining the audio embeddings and text embeddings using a text biasing layer; providing predicted probabilities for each token based on the combined embeddings; determining whether the target keyword is present in the input audio signal based on the predicted probabilities; and transmitting an alert based on the determining that the target keyword is present. Decoding may comprise using a sliding window and smoothing the predicted probabilities within the sliding window. Decoding may comprise using a technique that includes using computation of the maximum log probability in the sequence of the same token predictions. The method may further comprise comparing a decoding score to a threshold to determine if the target keyword is present. The text encoder may comprise a learnable embedding layer. The text biasing layer may comprise a transformer block with a multihead cross-attention layer. The combining step may be repeated using multiple text biasing layers. The customized keyword spotting model may be trained without using word-level segmentation or alignment information. The audio encoder may comprise a stack of linearized convolution network (LiCoNet) layers. A no bias token may be added to the target keyword. All combinations (including the removal or addition of steps) in this paragraph and the above paragraphs are contemplated in a manner that is consistent with the other portions of the detailed description.

A device may comprise a processor and a memory storing instructions that, when executed by the processor, cause the device to receive an input audio signal; determine the use of a target keyword in the input audio signal based on a customized keyword spotting model associated with spotting one or more keywords in the input audio signal; and send instructions to execute an action based on the use of the keyword. The action may comprise executing an operation associated with an application, which may include opening the application, transmitting data to the application, playing audio, playing video, displaying text, or closing the application. The keyword spotting model may execute operations that comprise receiving the input audio signal; receiving the target keyword as input bias text; generating audio embeddings based on processing the input audio signal through an audio encoder; generating text embeddings based on processing the target keyword through a text encoder; combining the audio embeddings and text embeddings using a text biasing layer; providing predicted probabilities for each token based on the combined embeddings; determining whether the target keyword is present in the input audio signal based on the predicted probabilities; and transmitting a message based on the determining that the target keyword is present. The device may comprise a mobile phone, a laptop, a smart speaker, a head mounted display, or a wearable device. All combinations (including the removal or addition of steps) in this paragraph and the above paragraphs are contemplated in a manner that is consistent with the other portions of the detailed description.

### Example Extended-Reality Systems

FIGS. 7A, 7B, 7C-1, and 7C-2, illustrate example XR systems that include AR and MR systems, in accordance with some embodiments. FIG. 7A shows a first XR system 700a and first example user interactions using a wrist-wearable device 726, a head-wearable device (e.g., AR device 728), and/or a HIPD 742. FIG. 7B shows a second XR system 700b and second example user interactions using a wrist-wearable device 726, AR device 728, and/or an HIPD 742. FIGS. 7C-1 and 7C-2 show a third MR system 700c and third example user interactions using a wrist-wearable device 726, a head-wearable device (e.g., an MR device such as a VR device), and/or an HIPD 742. As the skilled artisan will appreciate upon reading the descriptions provided herein, the above-example AR and MR systems (described in detail below) can perform various functions and/or operations.

The wrist-wearable device 726, the head-wearable devices, and/or the HIPD 742 can communicatively couple via a network 725 (e.g., cellular, near field, Wi-Fi, personal area network, wireless LAN). Additionally, the wrist-wearable device 726, the head-wearable device, and/or the HIPD 742 can also communicatively couple with one or more servers 730, computers 740 (e.g., laptops, computers), mobile devices 750 (e.g., smartphones, tablets), and/or other electronic devices via the network 725 (e.g., cellular, near field, Wi-Fi, personal area network, wireless LAN). Similarly, a smart textile-based garment, when used, can also communicatively couple with the wrist-wearable device 726, the head-wearable device(s), the HIPD 742, the one or more servers 730, the computers 740, the mobile devices 750, and/or other electronic devices via the network 725 to provide inputs.

Turning to FIG. 7A, a user 703 is shown wearing the wrist-wearable device 726 and the AR device 728 and having the HIPD 742 on their desk. The wrist-wearable device 726, the AR device 728, and the HIPD 742 facilitate user interaction with an AR environment. In particular, as shown by the first AR system 700a, the wrist-wearable device 726, the AR device 728, and/or the HIPD 742 cause presentation of one or more avatars 705, digital representations of contacts 707, and virtual objects 709. As discussed below, the user 703 can interact with the one or more avatars 705, digital representations of the contacts 707, and virtual objects 709 via the wrist-wearable device 726, the AR device 728, and/or the HIPD 742. In addition, the user 703 is also able to directly view physical objects in the environment, such as a physical table 729, through transparent lens(es) and waveguide(s) of the AR device 728. Alternatively, an MR device could be used in place of the AR device 728 and a similar user experience can take place, but the user would not be directly viewing physical objects in the environment, such as table 729, and would instead be presented with a virtual reconstruction of the table 729 produced from one or more sensors of the MR device (e.g., an outward facing camera capable of recording the surrounding environment).

The user 703 can use any of the wrist-wearable device 726, the AR device 728 (e.g., through physical inputs at the AR device and/or built-in motion tracking of a user's extremities), a smart-textile garment, externally mounted extremity tracking device, the HIPD 742 to provide user inputs, etc. For example, the user 703 can perform one or more hand gestures that are detected by the wrist-wearable device 726 (e.g., using one or more EMG sensors and/or IMUs built into the wrist-wearable device) and/or AR device 728 (e.g., using one or more image sensors or cameras) to provide a user input. Alternatively, or additionally, the user 703 can provide a user input via one or more touch surfaces of the wrist-wearable device 726, the AR device 728, and/or the HIPD 742, and/or voice commands captured by a microphone of the wrist-wearable device 726, the AR device 728, and/or the HIPD 742. The wrist-wearable device 726, the AR device 728, and/or the HIPD 742 include an artificially intelligent digital assistant to help the user in providing a user input (e.g., completing a sequence of operations, suggesting different operations or commands, providing reminders, confirming a command). For example, the digital assistant can be invoked through an input occurring at the AR device 728 (e.g., via an input at a temple arm of the AR device 728). In some embodiments, the user 703 can provide a user input via one or more facial gestures and/or facial expressions. For example, cameras of the wrist-wearable device 726, the AR device 728, and/or the HIPD 742 can track the user 703's eyes for navigating a user interface.

The wrist-wearable device 726, the AR device 728, and/or the HIPD 742 can operate alone or in conjunction to allow the user 703 to interact with the AR environment. In some embodiments, the HIPD 742 is configured to operate as a central hub or control center for the wrist-wearable device 726, the AR device 728, and/or another communicatively coupled device. For example, the user 703 can provide an input to interact with the AR environment at any of the wrist-wearable device 726, the AR device 728, and/or the HIPD 742, and the HIPD 742 can identify one or more back-end and front-end tasks to cause the performance of the requested interaction and distribute instructions to cause the performance of the one or more back-end and front-end tasks at the wrist-wearable device 726, the AR device 728, and/or the HIPD 742. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 742 can perform the back-end tasks and provide the wrist-wearable device 726 and/or the AR device 728 operational data corresponding to the performed back-end tasks such that the wrist-wearable device 726 and/or the AR device 728 can perform the front-end tasks. In this way, the HIPD 742, which has more computational resources and greater thermal headroom than the wrist-wearable device 726 and/or the AR device 728, performs computationally intensive tasks and reduces the computer resource utilization and/or power usage of the wrist-wearable device 726 and/or the AR device 728.

In the example shown by the first AR system 700a, the HIPD 742 identifies one or more back-end tasks and front-end tasks associated with a user request to initiate an AR video call with one or more other users (represented by the avatar 705 and the digital representation of the contact 707) and distributes instructions to cause the performance of the one or more back-end tasks and front-end tasks. In particular, the HIPD 742 performs back-end tasks for processing and/or rendering image data (and other data) associated with the AR video call and provides operational data associated with the performed back-end tasks to the AR device 728 such that the AR device 728 performs front-end tasks for presenting the AR video call (e.g., presenting the avatar 704 and the digital representation of the contact 707).

In some embodiments, the HIPD 742 can operate as a focal or anchor point for causing the presentation of information. This allows the user 703 to be generally aware of where information is presented. For example, as shown in the first AR system 700a, the avatar 705 and the digital representation of the contact 707 are presented above the HIPD 742. In particular, the HIPD 742 and the AR device 728 operate in conjunction to determine a location for presenting the avatar 705 and the digital representation of the contact 707. In some embodiments, information can be presented within a predetermined distance from the HIPD 742 (e.g., within five meters). For example, as shown in the first AR system 700a, virtual object 709 is presented on the desk some distance from the HIPD 742. Similar to the above example, the HIPD 742 and the AR device 728 can operate in conjunction to determine a location for presenting the virtual object 709. Alternatively, in some embodiments, presentation of information is not bound by the HIPD 742. More specifically, the avatar 705, the digital representation of the contact 707, and the virtual object 709 do not have to be presented within a predetermined distance of the HIPD 742. While an AR device 728 is described working with an HIPD, an MR headset can be interacted with in the same way as the AR device 728.

User inputs provided at the wrist-wearable device 726, the AR device 728, and/or the HIPD 742 are coordinated such that the user can use any device to initiate, continue, and/or complete an operation. For example, the user 703 can provide a user input to the AR device 728 to cause the AR device 728 to present the virtual object 709 and, while the virtual object 709 is presented by the AR device 728, the user 703 can provide one or more hand gestures via the wrist-wearable device 726 to interact and/or manipulate the virtual object 709. While an AR device 728 is described working with a wrist-wearable device 726, an MR headset can be interacted with in the same way as the AR device 728.

Integration of Artificial Intelligence with XR Systems

FIG. 7A illustrates an interaction in which an artificially intelligent virtual assistant can assist in requests made by a user 703. The AI virtual assistant can be used to complete open-ended requests made through natural language inputs by a user 703. For example, in FIG. 7A the user 703 makes an audible request 744 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 7A also illustrates an example neural network 752 used in Artificial Intelligence applications. Uses of Artificial Intelligence (AI) are varied and encompass many different aspects of the devices and systems described herein. AI capabilities cover a diverse range of applications and deepen interactions between the user 703 and user devices (e.g., the AR device 728, an MR device 732, the HIPD 742, the wrist-wearable device 726). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an A1 virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 703 can interact with an AI model through natural language inputs captured by a voice sensor, text inputs, or any other input modality that accepts natural language and/or a corresponding voice sensor module. In another instance, input is provided by tracking the eye gaze of a user 703 via a gaze tracker module. Additionally, the AI model can also receive inputs beyond those supplied by a user 703. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 728) or from multiple devices that are in communication with each other (e.g., a system that includes at least two of an AR device 728, an MR device 732, the HIPD 742, the wrist-wearable device 726, etc.). The AI model can also access additional information (e.g., one or more servers 730, the computers 740, the mobile devices 750, and/or other electronic devices) via a network 725.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 728, an MR device 732, the HIPD 742, the wrist-wearable device 726) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 728, an MR device 732, the HIPD 742, the wrist-wearable device 726), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 742), haptic feedback can provide information to the user 703. An AI model can also use the inputs described above to determine the appropriate modality and device(s) to present content to the user (e.g., a user walking on a busy road can be presented with an audio output instead of a visual output to avoid distracting the user 703).

### Example Augmented Reality Interaction

FIG. 7B shows the user 703 wearing the wrist-wearable device 726 and the AR device 728 and holding the HIPD 742. In the second AR system 700b, the wrist-wearable device 726, the AR device 728, and/or the HIPD 742 are used to receive and/or provide one or more messages to a contact of the user 703. In particular, the wrist-wearable device 726, the AR device 728, and/or the HIPD 742 detect and coordinate one or more user inputs to initiate a messaging application and prepare a response to a received message via the messaging application.

In some embodiments, the user 703 initiates, via a user input, an application on the wrist-wearable device 726, the AR device 728, and/or the HIPD 742 that causes the application to initiate on at least one device. For example, in the second AR system 700b the user 703 performs a hand gesture associated with a command for initiating a messaging application (represented by messaging user interface 713); the wrist-wearable device 726 detects the hand gesture; and, based on a determination that the user 703 is wearing the AR device 728, causes the AR device 728 to present a messaging user interface 713 of the messaging application. The AR device 728 can present the messaging user interface 713 to the user 703 via its display (e.g., as shown by user 703's field of view 711). In some embodiments, the application is initiated and can be run on the device (e.g., the wrist-wearable device 726, the AR device 728, and/or the HIPD 742) that detects the user input to initiate the application, and the device provides another device operational data to cause the presentation of the messaging application. For example, the wrist-wearable device 726 can detect the user input to initiate a messaging application, initiate and run the messaging application, and provide operational data to the AR device 728 and/or the HIPD 742 to cause presentation of the messaging application. Alternatively, the application can be initiated and run at a device other than the device that detected the user input. For example, the wrist-wearable device 726 can detect the hand gesture associated with initiating the messaging application and cause the HIPD 742 to run the messaging application and coordinate the presentation of the messaging application.

Further, the user 703 can provide a user input provided at the wrist-wearable device 726, the AR device 728, and/or the HIPD 742 to continue and/or complete an operation initiated at another device. For example, after initiating the messaging application via the wrist-wearable device 726 and while the AR device 728 presents the messaging user interface 713, the user 703 can provide an input at the HIPD 742 to prepare a response (e.g., shown by the swipe gesture performed on the HIPD 742). The user 703's gestures performed on the HIPD 742 can be provided and/or displayed on another device. For example, the user 703's swipe gestures performed on the HIPD 742 are displayed on a virtual keyboard of the messaging user interface 713 displayed by the AR device 728.

In some embodiments, the wrist-wearable device 726, the AR device 728, the HIPD 742, and/or other communicatively coupled devices can present one or more notifications to the user 703. The notification can be an indication of a new message, an incoming call, an application update, a status update, etc. The user 703 can select the notification via the wrist-wearable device 726, the AR device 728, or the HIPD 742 and cause presentation of an application or operation associated with the notification on at least one device. For example, the user 703 can receive a notification that a message was received at the wrist-wearable device 726, the AR device 728, the HIPD 742, and/or other communicatively coupled device and provide a user input at the wrist-wearable device 726, the AR device 728, and/or the HIPD 742 to review the notification, and the device detecting the user input can cause an application associated with the notification to be initiated and/or presented at the wrist-wearable device 726, the AR device 728, and/or the HIPD 742.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 728 can present to the user 703 game application data and the HIPD 742 can use a controller to provide inputs to the game. Similarly, the user 703 can use the wrist-wearable device 726 to initiate a camera of the AR device 728, and the user can use the wrist-wearable device 726, the AR device 728, and/or the HIPD 742 to manipulate the image capture (e.g., zoom in or out, apply filters) and capture image data.

While an AR device 728 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 7C-1 and 7C-2, the user 703 is shown wearing the wrist-wearable device 726 and an MR device 732 (e.g., a device capable of providing either an entirely VR experience or an MR experience that displays object(s) from a physical environment at a display of the device) and holding the HIPD 742. In the third AR system 700c, the wrist-wearable device 726, the MR device 732, and/or the HIPD 742 are used to interact within an MR environment, such as a VR game or other MR/VR application. While the MR device 732 presents a representation of a VR game (e.g., first MR game environment 720) to the user 703, the wrist-wearable device 726, the MR device 732, and/or the HIPD 742 detect and coordinate one or more user inputs to allow the user 703 to interact with the VR game.

In some embodiments, the user 703 can provide a user input via the wrist-wearable device 726, the MR device 732, and/or the HIPD 742 that causes an action in a corresponding MR environment. For example, the user 703 in the third MR system 700c (shown in FIG. 7C-1) raises the HIPD 742 to prepare for a swing in the first MR game environment 720. The MR device 732, responsive to the user 703 raising the HIPD 742, causes the MR representation of the user 722 to perform a similar action (e.g., raise a virtual object, such as a virtual sword 724). In some embodiments, each device uses respective sensor data and/or image data to detect the user input and provide an accurate representation of the user 703's motion. For example, image sensors (e.g., SLAM cameras or other cameras) of the HIPD 742 can be used to detect a position of the HIPD 742 relative to the user 703's body such that the virtual object can be positioned appropriately within the first MR game environment 720; sensor data from the wrist-wearable device 726 can be used to detect a velocity at which the user 703 raises the HIPD 742 such that the MR representation of the user 722 and the virtual sword 724 are synchronized with the user 703's movements; and image sensors of the MR device 732 can be used to represent the user 703's body, boundary conditions, or real-world objects within the first MR game environment 720.

In FIG. 7C-2, the user 703 performs a downward swing while holding the HIPD 742. The user 703's downward swing is detected by the wrist-wearable device 726, the MR device 732, and/or the HIPD 742 and a corresponding action is performed in the first MR game environment 720. In some embodiments, the data captured by each device is used to improve the user's experience within the MR environment. For example, sensor data of the wrist-wearable device 726 can be used to determine a speed and/or force at which the downward swing is performed and image sensors of the HIPD 742 and/or the MR device 732 can be used to determine a location of the swing and how it should be represented in the first MR game environment 720, which, in turn, can be used as inputs for the MR environment (e.g., game mechanics, which can use detected speed, force, locations, and/or aspects of the user 703's actions to classify a user's inputs (e.g., user performs a light strike, hard strike, critical strike, glancing strike, miss) or calculate an output (e.g., amount of damage)).

FIG. 7C-2 further illustrates that a portion of the physical environment is reconstructed and displayed at a display of the MR device 732 while the MR game environment 720 is being displayed. In this instance, a reconstruction of the physical environment 746 is displayed in place of a portion of the MR game environment 720 when object(s) in the physical environment are potentially in the path of the user (e.g., a collision with the user and an object in the physical environment are likely). Thus, this example MR game environment 720 includes (i) an immersive VR portion 748 (e.g., an environment that does not have a corollary counterpart in a nearby physical environment) and (ii) a reconstruction of the physical environment 746 (e.g., table 750 and cup). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 726, the MR device 732, and/or the HIPD 742 are described as detecting user inputs, in some embodiments, user inputs are detected at a single device (with the single device being responsible for distributing signals to the other devices for performing the user input). For example, the HIPD 742 can operate an application for generating the first MR game environment 720 and provide the MR device 732 with corresponding data for causing the presentation of the first MR game environment 720, as well as detect the user 703's movements (while holding the HIPD 742) to cause the performance of corresponding actions within the first MR game environment 720. Additionally or alternatively, in some embodiments, operational data (e.g., sensor data, image data, application data, device data, and/or other data) of one or more devices is provided to a single device (e.g., the HIPD 742) to process the operational data and cause respective devices to perform an action associated with processed operational data.

In some embodiments, the user 703 can wear a wrist-wearable device 726, wear an MR device 732, wear smart textile-based garments 738 (e.g., wearable haptic gloves), and/or hold an HIPD 742 device. In this embodiment, the wrist-wearable device 726, the MR device 732, and/or the smart textile-based garments 738 are used to interact within an MR environment (e.g., any AR or MR system described above in reference to FIGS. 7A-7B). While the MR device 732 presents a representation of an MR game (e.g., second MR game environment 720) to the user 703, the wrist-wearable device 726, the MR device 732, and/or the smart textile-based garments 738 detect and coordinate one or more user inputs to allow the user 703 to interact with the MR environment.

In some embodiments, the user 703 can provide a user input via the wrist-wearable device 726, an HIPD 742, the MR device 732, and/or the smart textile-based garments 738 that causes an action in a corresponding MR environment. In some embodiments, each device uses respective sensor data and/or image data to detect the user input and provide an accurate representation of the user 703's motion. While four different input devices are shown (e.g., a wrist-wearable device 726, an MR device 732, an HIPD 742, and a smart textile-based garment 738) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 738) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 738 can be used in conjunction with an MR device and/or an HIPD 742.

While some experiences are described as occurring on an AR device and other experiences are described as occurring on an MR device, one skilled in the art would appreciate that experiences can be ported over from an MR device to an AR device, and vice versa.

### Other Interactions

While numerous examples are described in this application related to extended-reality environments, one skilled in the art would appreciate that certain interactions may be possible with other devices. For example, a user may interact with a robot (e.g., a humanoid robot, a task specific robot, or other type of robot) to perform tasks inclusive of, leading to, and/or otherwise related to the tasks described herein. In some embodiments, these tasks can be user specific and learned by the robot based on training data supplied by the user and/or from the user's wearable devices (including head-worn and wrist-worn, among others) in accordance with techniques described herein. As one example, this training data can be received from the numerous devices described in this application (e.g., from sensor data and user-specific interactions with head-wearable devices, wrist-wearable devices, intermediary processing devices, or any combination thereof). Other data sources are also conceived outside of the devices described here. For example, AI models for use in a robot can be trained using a blend of user-specific data and non-user specific-aggregate data. The robots may also be able to perform tasks wholly unrelated to extended reality environments, and can be used for performing quality-of-life tasks (e.g., performing chores, completing repetitive operations, etc.). In certain embodiments or circumstances, the techniques and/or devices described herein can be integrated with and/or otherwise performed by the robot.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

What is claimed:

1. A method for training a customized keyword spotting model, comprising:
receiving an input audio signal;
receiving a transcript that corresponds with the input audio signal;
receiving an input bias text;
modifying the transcript to include words that overlap with the input bias text to generate a modified transcript;
generating audio embeddings based on processing the input audio signal through an audio encoder;
generating text embeddings based on processing the input bias text through a text encoder;
combining the audio embeddings and text embeddings using a text biasing layer to generate combined embeddings;
providing predicted probabilities for respective tokens based on the combined embeddings;
determining a loss between the predicted probabilities and the modified transcript using Connectionist Temporal Classification (CTC) loss; and
updating parameters of the model based on the loss.

2. The method of claim 1, wherein the input bias text is randomly selected from the transcript.

3. The method of claim 1, wherein the text encoder comprises a learnable embedding layer.

4. The method of claim 1, wherein the text biasing layer comprises a transformer block with a multihead cross-attention layer.

5. The method of claim 1, wherein combining the audio embeddings and text embeddings using the text biasing layer to generate the combined embeddings includes combining the audio embeddings and the text embeddings using a first text biasing layer and a second text biasing layer distinct from the first text biasing layer to generate the combined embeddings.

6. The method of claim 1, wherein modifying the transcript comprises replacing the transcript with a blank token if no words overlap with the input bias text.

7. The method of claim 1, further comprising training the model using a dataset without word-level segmentation or alignment information.

8. The method of claim 1, wherein the audio encoder comprises a stack of linearized convolution network (LiCoNet) layers.

9. The method of claim 1, further comprising adding a no bias token to the input bias text.

10. A method for keyword spotting comprising:
receiving an input audio signal;
receiving a target keyword as input bias text;
generating audio embeddings based on processing the input audio signal through an audio encoder;
generating text embeddings based on processing the target keyword through a text encoder;
combining the audio embeddings and text embeddings using a text biasing layer to generate combined embeddings;
providing predicted probabilities for each token of one or more tokens based on the combined embeddings;
determining whether the target keyword is present in the input audio signal based on the predicted probabilities; and
transmitting an alert based on the determining that the target keyword is present.

11. The method of claim 10, wherein providing the predicted probabilities comprises using a sliding window, and the method further comprising smoothing the predicted probabilities within the sliding window.

12. The method of claim 10, wherein providing the predicted probabilities comprises computing a maximum log probability in a sequence of predicted probabilities for the one or more tokens.

13. The method of claim 10, wherein determining whether the target keyword is present is based on comparing the predicted probabilities to a predetermined threshold.

14. The method of claim 10, wherein the text encoder comprises a learnable embedding layer.

15. The method of claim 10, wherein the text biasing layer comprises a transformer block with a multihead cross-attention layer.

16. The method of claim 10, wherein the audio embeddings and the text embeddings are combined using the text biasing layer without external alignment information.

17. The method of claim 10, wherein the audio encoder comprises a stack of linearized convolution network (LiCoNet) layers.

18. A device comprising:
a processor; and
a memory storing instructions that, when executed by the processor, cause the device to:
receive an input audio signal;
determine the use of a target keyword in the input audio signal based on a customized keyword spotting model associated with spotting one or more keywords in the input audio signal, wherein the customized keyword spotting model comprises:
receiving the input audio signal;
receiving the target keyword as input bias text;
generating audio embeddings based on processing the input audio signal through an audio encoder;
generating text embeddings based on processing the target keyword through a text encoder;
combining the audio embeddings and text embeddings using a text biasing layer to generate combined embeddings;
providing predicted probabilities for each token of one or more tokens based on the combined embeddings;
determining whether the target keyword is present in the input audio signal based on the predicted probabilities; and
transmitting a message based on the determining that the target keyword is present; and
send instructions to execute an action based on the use of the target keyword.

19. The device of claim 18, wherein the action comprises executing an operation associated with an application, wherein the action comprises opening the application, transmitting data to the application, playing audio, playing video, display text, or closing the application.

20. The device of claim 18, wherein the device comprises a mobile phone, a laptop, a smart speaker, a head mounted display, or a wearable device.
